(19) United States
(12) Patent Application Publication
(10) Pub. No.: US 2014/0110647 A1
(43) Pub. Date: Apr. 24, 2014

(54) INTERCHANGEABLE TRANSMISSION CRADLE ATTACHMENT FOR LIFT JACK

(71) Applicant: Danijel Filipovic, Taylorsville, UT (US)

(72) Inventor: Danijel Filipovic, Taylorsville, UT (US)

(21) Appl. No.: 13/656,648

(22) Filed: Oct. 19, 2012

(51) Int. Cl. B66F 3/00

(52) U.S. Cl. 254/133 R

(57) ABSTRACT

An interchangeable transmission cradle is disclosed which is affixable to standard jack used in automotive repair. The disclosed cradle allows an operator to position the cradle on a jack below a transmission, gear box, or the like. The cradle's unique triangular shape, which is concave in some embodiments, allows the cradle to support the underside of a conically-shaped transmission or gear box. The cradle is supported by three support arms axially rotatable around the jack. The cradle comprises one or more straps or chains adjustably affixed to the distal ends of the support arms, which circumscribe the transmission or gearbox.

### BACKGROUND OF THE INVENTION

1. Field of the Invention

This invention relates to automotive repair implements, and more particularly relates to lift jack attachments for lifting automotive transmissions.

2. Description of the Related Art

Automotive transmissions are often located in tightly confined spaces, adjacent the car frame, exhaust system or other components. These conically-shaped transmissions are cumbersome and cannot be lifted or supported by repair implements used with other vehicle components.

The prior art includes varies species of transmission jacks of various sizes and shapes, which incorporate multiple design features purportedly helpful in supporting and removing transmissions from automobiles. The actual utility and functionality of the devices taught in the prior art is limited. While the prior art teaches lifting jacks designed specifically for transmissions, these jacks comprising intricate apparati of multiple vertically uprising arms, unbalanced and eccentric jacks of overly complex configurations which do not assist repair personnel meaningfully in their tasks or contribute to efficient use of time.

Operators of traditional transmission jacks and personnel working in the automotive industry find traditional devices cumbersome, expensive, and incompatible with either their efficiency goals or standard equipment found in typical automotive repair locations. There exists a need in the industry for a light jack attachment, which is interchangeable with typical jacks in repair locations, which includes design features which allow an operator to conveniently and effectively support a conically-shaped transmission as it is removed from the body of an automobile.

It is desirable that this device be able to suspend the transmission on the jack, while also being interchangeable with other jack components, easily storable, and inexpensive. It is the object of the present invention to provide a device which meets these needs.

### SUMMARY OF THE INVENTION

From the foregoing discussion, it should be apparent that a need exists for an interchangeable transmission cradle attachment for a lift jack. The present invention has been developed in response to the present state of the art; and, in particular, in response to the problems and needs in the art that have not yet been fully solved by currently available methods, systems and apparati, and that overcome many or all of the above-discussed shortcomings in the art. Accordingly, the present invention has been developed to provide an interchangeable transmission cradle attachment for a lift jack, the transmission cradle attachment for supporting an automotive transmission, the transmission cradle attachment comprising: three elongated rigid arms radiating from a center point, the three elongated arms affixed to one another at the center point, each elongated arm having a proximal end affixed at the center point and distal end extending away from the center point, wherein each distal end defines an aperture for receiving one of a strap and chain; one of a strap and a chain detachably affixed to one or more of the elongated arm(s) via an aperture, the strap and chain for circumscribing and securing a transmission resting upon the cradle attachment; a cylindrical male fitting component affixed to the center point and extending downward orthogonally away from the center point, the cylindrical male fitting component for engaging a female socket on a lift jack.

The elongated arms may be welded together. In other embodiments, the elongated arms may be stamped from a metal sheet. Each of the elongated members may curve upward away from the center point imparting a concave shape to the transmission cradle for receiving a conically-shaped transmission.

Each of the elongated arms may be spaced evenly apart axially from one another. Two of the elongated arms may be spaced closer to one another axially such that the transmission cradle forms a Y-shape. In some embodiments, one of the elongated arms may longer than the remaining two elongated arms.

In some embodiments, the interchangeable transmission cradle attachment may further comprise a planar baseplate affixed over the center point. The transmission cradle attachment and baseplate may be fabricated as a single integrated piece. One or more of the elongated arms may be forked at the end. One or more of the elongated arm(s) may further comprise polymeric pads affixed to the distal end(s) of the elongated arm(s). The baseplate may further define one or more apertures. The interchangeable transmission cradle attachment may further comprise a plurality of pegs detachably insertable into the apertures.

A second interchangeable transmission cradle attachment for a lift jack is disclosed, the transmission cradle attachment for supporting an automotive transmission, the transmission cradle attachment comprising: three elongated rigid arms radiating from a center point, the three elongated arms affixed to one another at the center point, each elongated arm having a proximal end affixed at the center point and distal end extending away from the center point; one or more D-ring(s), each D-ring affixed to the distal end of an elongated arm; one of a strap and a chain detachably affixed to one or more of the elongated arm(s) via a D-ring, the strap and chain for circumscribing and securing a transmission resting on the transmission cradle attachment; and a cylindrical fitting component affixed to the center point and extending downward orthogonally away from the center point, the cylindrical male component for engaging a female socket on a lift jack.

Each of the elongated members may curve upward away from the center point imparting a concave shape to the transmission cradle for receiving a conically-shaped transmission. In various embodiments, each of the elongated arms are spaced evenly apart axially from one another. In the second independent disclosure, as the first, two of the elongated arms are spaced closer to one another axially such that the transmission cradle forms a Y-shape. The interchangeable transmission cradle attachment may further comprise a planar baseplate affixed over the center point. The transmission cradle attachment and baseplate may also be fabricated as a single integrated piece.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is an upper elevational perspective view of an interchangeable transmission cradle attachment for a lift jack in accordance with the present invention;

FIG. 1B is a lower elevational perspective view of an interchangeable transmission cradle attachment for a lift jack in accordance with the present invention;

FIG. 2 is an upper elevational perspective view of an interchangeable transmission cradle attachment for a lift jack in accordance with the present invention;

FIG. 3 is a lower side perspective view of an interchangeable transmission cradle attachment for a lift jack in accordance with the present invention;

FIG. 4A is a top perspective view of an interchangeable transmission cradle attachment for a lift jack in accordance with the present invention;

FIG. 4B is a top perspective view of an interchangeable transmission cradle attachment for a lift jack with an exploded view of a peg in accordance with the present invention;

FIG. 5A is an upper environmental elevational perspective view of an interchangeable transmission cradle attachment for a lift jack in accordance with the present invention; and

FIG. 5B is an upper environmental elevational perspective view of an interchangeable transmission cradle attachment for a lift jack in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

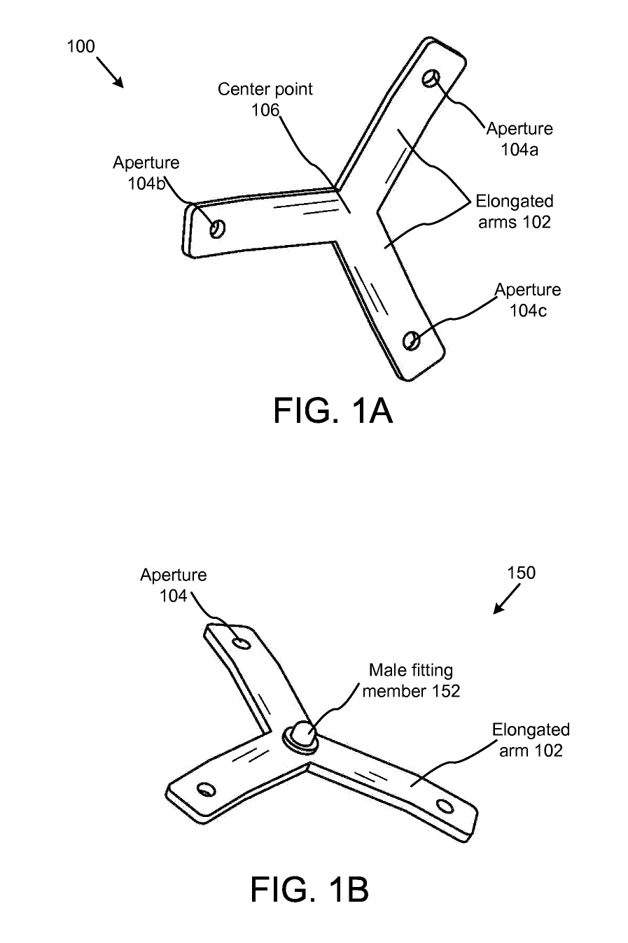

FIG. 1A is an upper elevational perspective view of an interchangeable transmission cradle attachment for a lift jack in accordance with the present invention. The cradle attachment 100 comprises three elongated arms 102, three apertures 104a-c, and a center point.

The elongated arms 102, in the shown embodiment, comprises substantially planar rigid metal alloy extensions originating at a center point 106. Each of the elongated arms 102 extends radially from the center point 106.

In some embodiments, the elongated arms form a geometric plane. In other embodiments, the elongated arms curve upward away from the center point 106 giving the cradle 100 a concave shape from an upper perspective view and a convex shape from a lower perspective view.

In various embodiments, the elongated arms 102 are each bored at their distal ends to define a recess or aperture 104 for receiving a strap, chain, rope, tie down, or the like for affixing an automotive transmission to the cradle 100. These straps or chains may be affixed using fittings, couplers, or fasteners of any kind known to those of skill in the art.

In the shown embodiment, the defined apertures 104a-c are annular in shape and traverse the elongated arms longitudinally. In other embodiments, the apertures 104a-c may traverse the elongated arms 102 laterally and/or be irregularly shaped as defined by the elongated arms 102, or shaped cylindrically, conically, spherically, cubically, or polygonially.

In still further embodiments, rings are affixed to the distal ends of the elongated arms 102, which rings define the aperture(s) 104.

FIG. 1B is a lower elevational perspective view of an interchangeable transmission cradle attachment 150 for a lift jack in accordance with the present invention. The transmission cradle 150 comprises a elongated arm 102, an aperture 104, and a male fitting member 152.

The aperture 104 and elongated arm 102 are substantially described in relation to FIG. 1A.

The cradle 150 is affixed to a male fitting member 152. In the shown embodiment, the male fitting member 152 juts downward orthogonally from the center point 106 of the cradle 150. The male fitting member 152 is received by a corresponding female fitting member on a lift jack known to those of skill in the art.

Because the male fitting member 152 is cylindrically-shaped, the cradle 150 may be freely rotated axially around the jack such that an operator can more readily position the cradle 150 beneath an automotive transmission.

In various embodiments, the male fitting member male interlock with the jack using cotter pins, clamps and/or other fitting or coupling mechanisms as known to those of skill in the art. While the shown male fitting member 152 is cylindrical, the male fitting member may be fabricated in the form any shape necessary to receive, be received, or interlock with a corresponding member on a lift jack.

The cradle 150 may, in some embodiments, be permanently attached to the head of a jack. The jack, in some embodiments, comprises a bottle jack, a high jack, a high lift jack, a floor jack, a rolling jack, or any other jack known to those of skill in the art.

In other embodiments of the present invention, the cradle 150 is affixed to a female fitting member rather than a male 152, which female fitting member engages a lift jack in likewise fashion.

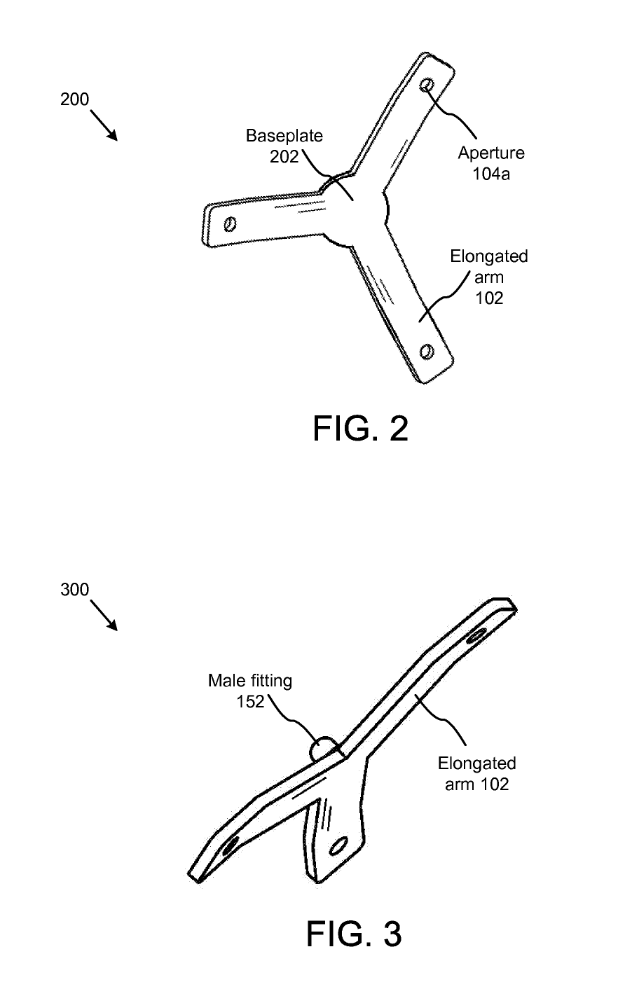

FIG. 2 is an upper elevational perspective view of an interchangeable transmission cradle attachment 200 for a lift jack in accordance with the present invention. The cradle 200 comprises an elongated arm 102, an aperture 104a, and a baseplate 202.

The aperture 104a and elongated arm 102 are substantially described above in relation to FIGS. 1A-1B.

In some embodiments of the present invention, the cradle 200 is affixed to a baseplate 202. The baseplate 202 may be affixed above or below the center point 106. In the shown embodiment, the base plate 202 is fabricated as a single integrated piece with the elongated arms 102 and cradle 200.

The baseplate 202 is a planar sheet and partially covers the proximal ends of the elongated arms 102. The baseplate 202 may be centered over the center point 106, or may be positioned eccentrically over the center point 106.

The baseplate 202 may be fabricated from metals such as iron, aluminum, titanium or the like; from metal alloys; from wood; from fiberglass; from silicone; or from polymeric materials as known to those of skill in the art.

In some embodiments, the baseplate 202 curves upwards or downward away from the center point 106 in concave or convex fashion.

FIG. 3 is a lower side perspective view of an interchangeable transmission cradle attachment 300 for a lift jack in accordance with the present invention. The cradle 300 comprises an elongated arm 102 and male fitting member 152.

The cradle 300 is designed as shown from the side.

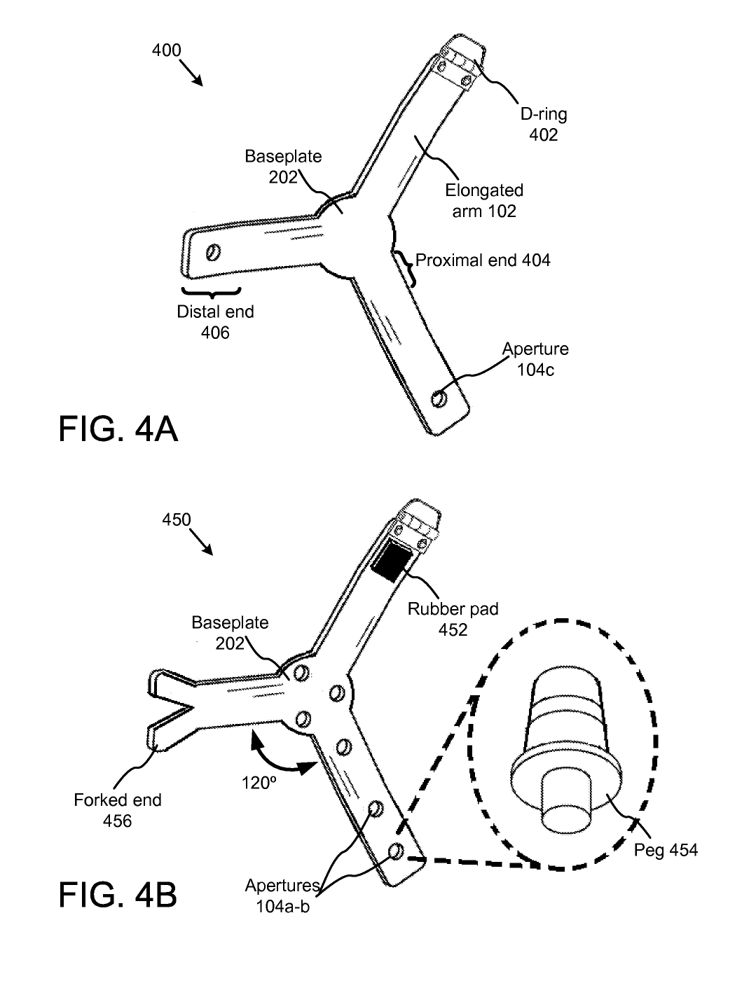

FIG. 4A is a top perspective view of an interchangeable transmission cradle attachment 400 for a lift jack in accordance with the present invention. The cradle 400 comprises an elongated arm 102, an aperture 104c, a baseplate 202, a proximal end 404, a distal end 406, and a D-ring 402.

The elongated arm 102, aperture 104c, and baseplate 202 are all substantially described above in relation to FIGS. 1A-3.

Each of the elongated arms 102 comprise a distal end 406 and a proximal end 404. The proximal ends 404 are affixed to one another at the center point 106, and rest under, above, or within the baseplate 202.

The cradle 400 is affixed, in the shown embodiment, to a D-ring 402. D-rings 402 are known to those of skill in the art. The D-ring 402 is bolted to the distal end 406 of the elongated arm 102.

While the shown embodiment consists of only a single D-ring 402, other embodiments comprise three D-rings 402, each affixed to a distal end 406 of a separate elongated arm 102.

The D-rings 402 engage chains, straps, ropes, tubes or other flexible lashing-type components for securing a transmission to the cradle 400. In some embodiments, the D-rings 402 are substituted for loops, hooks, hinges, buckles or other fasteners as known to those of skill in the art. The D-rings 402, and other fasteners, may be affixed permanently or detachably to the elongated arms 102 using means known to those of skill in the art, including bolts, welds, nails, adhesives, and the like.

FIG. 4B is a top perspective view of an interchangeable transmission cradle attachment 450 for a lift jack with an exploded view of peg 454 in accordance with the present invention. The cradle 450 comprises a baseplate 202, apertures 104a-b, a rubber pad 452, a peg 454, and a forked end 456.

In the shown embodiment, an elongated arm 102 comprises a rubber pad 452 on its upper surface. This rubber pad 452 is for the purpose of engaging a transmission with a more gentle surface than that of the elongated arm 102 itself. The rubber pad 452 may be made via any means known to those of skill in the art.

The elongated arms 102 in the shown embodiment are separated by 120 degrees. In some embodiments they are separated by as little as 5 degrees or as much as 300 degrees. Although the shown embodiment consists of three elongated arms 102. Various other embodiments consist of more than three elongated arms 102. In some embodiments of the present invention, one or more of the elongated arms 102 fork at their distal ends into a forked end 456.

The baseplate 202 comprises a plurality of apertures 104. The elongated arms 102 also may comprise a plurality of apertures 104.

Pegs 454 may be detachably inserted into the apertures 104. The pegs 454 engage the transmission, or targeted portions of it, and suspend the transmission above the cradle 450.

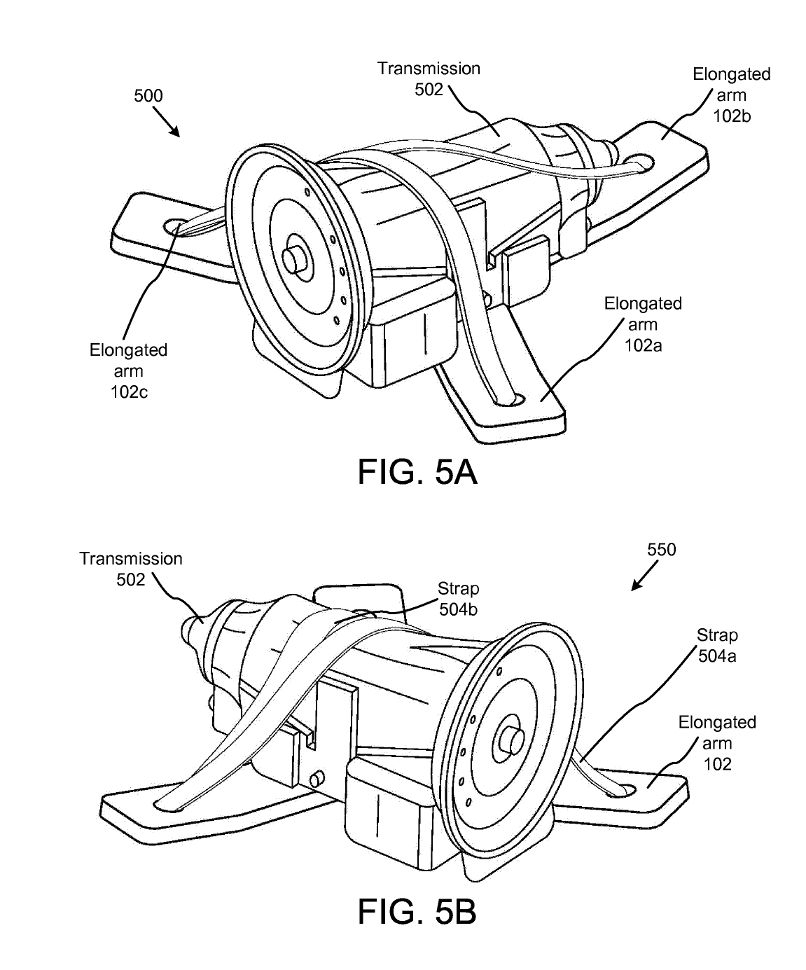

FIG. 5A is an upper environmental elevational perspective view of an interchangeable transmission cradle attachment for a lift jack 500 in accordance with the present invention. The cradle 500 comprises elongated arms 102a-c and a transmission 502.

The elongated arms 102a-c are substantially described above in relation to FIGS. 1A-4.

The transmission 502 rests upon the cradle 500 as shown, with the larger, wider portion of the conically-shaped transmission straddled by two of the elongated arms 102a and 102c, with the third elongated arm 102b supporting the narrower portion of the transmission 502.

FIG. 5B is an upper environmental elevational perspective view of an interchangeable transmission cradle 550 attachment for a lift jack in accordance with the present invention. The cradle 550 comprises an elongated arm 102, a strap 504a, a strap 504b, and a transmission 502.

The elongated arm 102 and straps 504a-b are substantially described above in relation to FIGS. 1A-5A.

The transmission 502 rests upon the cradle 550 in the shown embodiment as shown.

The functions of the systems shown in the present invention correspond generally to other methods and apparati outlined in the present invention, and further illustrates the availability of different allocations of functionality amongst modules that implement an embodiment of the invention. To the extent that hardware, software, and firmware implementations are deemed partially or fully interchangeable at the time in question (now or hereafter) by one of skill in the art, they may be utilized in embodying the invention even though the specific implementation examples discussed here are different.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An interchangeable transmission cradle attachment for a lift jack, the transmission cradle attachment for supporting an automotive transmission, the transmission cradle attachment comprising:
three elongated rigid arms radiating from a center point, the three elongated arms affixed to one another at the center point, each elongated arm having a proximal end affixed at the center point and distal end extending away from the center point, wherein each distal end defines an aperture for receiving one of a strap and chain;
one of a strap and a chain detachably affixed to one or more of the elongated arm(s) via an aperture, the strap and chain for circumscribing and securing a transmission resting upon the cradle attachment;
a cylindrical male fitting component affixed to the center point and extending downward orthogonally away from the center point, the cylindrical male fitting component for engaging a female socket on a lift jack.

2. The interchangeable transmission cradle attachment of claim 1, wherein the elongated arms are welded together.

3. The interchangeable transmission cradle attachment of claim 1, wherein the elongated arms are stamped from a metal sheet.

4. The interchangeable transmission cradle attachment of claim 1, wherein each of the elongated members curve upward away from the center point imparting a concave shape to the transmission cradle for receiving a conically-shaped transmission.

5. The interchangeable transmission cradle attachment of claim 1, wherein each of the elongated arms are spaced evenly apart axially from one another.

6. The interchangeable transmission cradle attachment of claim 1, wherein two of the elongated arms are spaced closer to one another axially such that the transmission cradle forms a Y-shape.

7. The interchangeable transmission cradle attachment of claim 1, wherein of the elongated arms is longer than the remaining two elongated arms.

8. The interchangeable transmission cradle attachment of claim 1, further comprising a planar baseplate affixed over the center point.

9. The interchangeable transmission cradle attachment of claim 8, wherein the transmission cradle attachment and baseplate are fabricated as a single integrated piece.

10. The interchangeable transmission cradle attachment of claim 1, wherein one or more of the elongated arms is forked at the end.

11. The interchangeable transmission cradle attachment of claim 1, wherein one or more of the elongated arm(s) further comprise polymeric pads affixed to the distal end(s) of the elongated arm(s).

12. The interchangeable transmission cradle attachment of claim 1, wherein the baseplate further defines one or more apertures.

13. The interchangeable transmission cradle attachment of claim 12, further comprising a plurality of pegs detachably insertable into the apertures.

14. An interchangeable transmission cradle attachment for a lift jack, the transmission cradle attachment for supporting an automotive transmission, the transmission cradle attachment comprising:
three elongated rigid arms radiating from a center point, the three elongated arms affixed to one another at the center point, each elongated arm having a proximal end affixed at the center point and distal end extending away from the center point;
one or more D-ring(s), each D-ring affixed to the distal end of an elongated arm;
one of a strap and a chain detachably affixed to one or more of the elongated arm(s) via a D-ring, the strap and chain for circumscribing and securing a transmission resting on the transmission cradle attachment and
a cylindrical fitting component affixed to the center point and extending downward orthogonally away from the center point, the cylindrical male component for engaging a female socket on a lift jack.

15. The interchangeable transmission cradle attachment of claim 14, wherein each of the elongated members curve upward away from the center point imparting a concave shape to the transmission cradle for receiving a conically-shaped transmission.

16. The interchangeable transmission cradle attachment of claim 14, wherein each of the elongated arms are spaced evenly apart axially from one another.

17. The interchangeable transmission cradle attachment of claim 14, wherein two of the elongated arms are spaced closer to one another axially such that the transmission cradle forms a Y-shape.

18. The interchangeable transmission cradle attachment of claim 14, further comprising a planar baseplate affixed over the center point.

19. The interchangeable transmission cradle attachment of claim 18, wherein the transmission cradle attachment and baseplate are fabricated as a single integrated piece.

20. The interchangeable transmission cradle attachment of claim 14, further comprising a plurality of pegs detachably insertable into the apertures, wherein the baseplate further defines one or more apertures.
